(19) United States
(12) Patent Application Publication
(10) Pub. No.: US 2026/0282201 A1
(43) Pub. Date: Sep. 17, 2026

(54) TUBE STAND APPARATUS AND X-RAY IMAGING SYSTEM

(71) Applicant: GE Precision Healthcare LLC, Waukesha, WI (US)

(72) Inventors: Jianqiang Yang, Beijing (CN); Gang Hong, Beijing (CN); Rongquan Yan, Beijing (CN); Yingying Wang, Beijing (CN); Jinfeng Wang, Beijing (CN)

(21) Appl. No.: 19/549,934

(22) Filed: Feb. 25, 2026

(30) Foreign Application Priority Data
Feb. 25, 2025 (CN) 202520319684.5

(51) Int. Cl. H05G 1/52; H05G 1/02

(52) U.S. Cl. CPC H05G 1/52; H05G 1/02

(57) ABSTRACT

Provided in the present application are a tube stand apparatus and an X-ray imaging system. The tube stand apparatus includes a stand, a cross arm mounted on the stand, and a tube. The tube stand apparatus further includes a tube tilting apparatus mounted between the tube and the cross arm. The tube tilting apparatus includes a tube holding assembly and an angle adjusting assembly. The tube holding assembly includes a clamping member and a fixing member. The clamping member is capable of holding the tube. The fixing member is provided with a stopping groove. The stopping groove defines a tilting angle of the tube. The angle adjusting assembly includes a protrusion matching the stopping groove. The protrusion is capable of being controlled to enter or leave the stopping groove, so as to realize the tilting movement of the tube relative to the cross arm.

### CROSS-REFERENCE TO RELATED APPLICATIONS

This application is based on and claims priority to Chinese Patent Application No. 202520319684.5, filed on Feb. 25, 2025, the entire contents of which is herein incorporated by reference.

### TECHNICAL FIELD

The present application relates to medical imaging technologies, and more specifically to a tube stand apparatus and an X-ray imaging system.

### BACKGROUND

In an X-ray imaging system, radiation from an X-ray source is emitted toward a subject, and the subject under examination is usually a patient in a medical diagnosis application. Some of the radiation passes through the subject under examination and impacts a detector, which is divided into a matrix of discrete elements (e.g., pixels). The detector elements are read to generate an output signal on the basis of the amount or intensity of radiation that impacts each pixel region. The signal can then be processed to generate a medical image that can be displayed for review, and the medical image can be displayed in a display apparatus of the X-ray imaging system.

The X-ray imaging system includes a suspended X-ray imaging system, a dual-stand X-ray imaging system, and a movable X-ray imaging system. The dual-stand X-ray imaging system includes a tube stand apparatus and a detector stand system. For the tube stand apparatus, a tube is generally carried by a cross arm, and the cross arm is mounted on a stand. In order to meet image capture needs, the tube must be tilted at a certain angle (upward or downward) relative to the cross arm in addition to being movable in a horizontal direction and a vertical direction and rotating around the cross arm. A conventional tilt control mechanism occupies a relatively large space, has a complex structure, requires a relatively large operating force, is inconvenient to control, and cannot be accurately positioned and maintained for a long time.

### SUMMARY

The present application provides a tube stand apparatus and an X-ray imaging system.

An exemplary embodiment of the present application provides a tube stand apparatus. The tube stand apparatus comprises a stand, a cross arm mounted on the stand, and a tube. The tube stand apparatus further comprises a tube tilting apparatus mounted between the tube and the cross arm. The tube tilting apparatus comprises a tube holding assembly and an angle adjusting assembly. The tube holding assembly comprises a clamping member and a fixing member. The clamping member is capable of holding the tube. The fixing member is provided with a stopping groove. The stopping groove defines a tilting angle of the tube. The angle adjusting assembly comprises a protrusion matching the stopping groove. The protrusion is capable of being controlled to enter or leave the stopping groove, so as to realize the tilting movement and holding of the tube relative to the cross arm.

Specifically, the clamping member comprises two hoops, and each hoop comprises a first hoop unit, a second hoop unit and a first connecting portion. An end of the first hoop unit is provided with a first hole. An end of the second hoop unit is provided with a second through hole. The first connecting portion is capable of fixing the first hoop unit and the second hoop unit by means of the first hole and the second through hole.

Specifically, an outer ring of one of the first hole and the second through hole is provided with a first groove. An outer ring of the other of the first hole and the second through hole is provided with a first protrusion matching the first groove. The first groove and the first protrusion can be engaged when the first hoop unit and the second hoop unit are fitted together.

Specifically, the fixing member comprises a first fixing unit and a second fixing unit that are fitted together, and the first fixing unit and the second fixing unit are fixed by a second connecting portion. The stopping groove is provided on the first fixing unit or the second fixing unit.

Specifically, the tube tilting apparatus further comprises a buffer assembly. The buffer assembly is positioned adjacent to the second connecting portion.

Specifically, the buffer assembly comprises a buffer member and a hydraulic apparatus. One end of the buffer member has a preset distance from the second connecting portion, and the other end of the buffer member is connected to the hydraulic apparatus.

Specifically, two ends of the stopping groove on the fixing member are each provided with a limiting block to limit a limit position of tilting of the tube.

Specifically, the angle adjusting assembly comprises a bracket, a first shaft and a second shaft that are arranged in parallel, an elastic member and at least one grip portion. The bracket comprises a main portion and two side portions. The first shaft and the second shaft are mounted between the two side portions, and the protrusion is mounted on the second shaft. The elastic member is wound around the first shaft, one end of the elastic member is supported on the main portion, and the other end of the elastic member is fixed to the second shaft. The at least one grip portion is mounted on the side portion.

Specifically, the at least one holding portion is mounted away from the protrusion.

Specifically, an end of the at least one grip portion is provided with a hexagonal socket.

Specifically, the angle adjusting assembly comprises two grip portions, the two grip portions are respectively mounted on the two side portions, and any one grip portion is capable of controlling the displacement of the protrusion.

Specifically, the second shaft has an irregular cross section.

Specifically, the tube stand apparatus further comprises a tube rotating apparatus. The tube rotating apparatus comprises a rotating bracket. One end of the rotating bracket is connected to the cross arm, and the other end of the rotating bracket is fixedly connected to the main portion.

Specifically, a group of second protrusions are provided on a side of the main portion connected to the rotating bracket.

Specifically, the rotating bracket comprises at least one slot thereon. The at least one slot is capable of accommodating the at least one grip portion, and the at least one slot is capable of defining a displacement distance of the at least one grip portion.

Specifically, the rotating bracket is further fixed to the clamping member, and a third group of grooves are provided on a side edge of the clamping member. A third group of protrusions matching the third group of grooves are provided on a side edge of the rotating bracket.

Specifically, an adjusting nut is further provided on the rotating bracket. The adjusting nut is capable of adjusting an initial position of the angle adjusting assembly.

Specifically, one end of the protrusion close to the fixing member is provided in a concave shape in the middle.

An exemplary embodiment of the present utility model provides an X-ray imaging system. The X-ray imaging system comprises the above-mentioned tube stand apparatus.

Other features and aspects will become apparent from the following detailed description, accompanying drawings, and claims.

### BRIEF DESCRIPTION OF THE DRAWINGS

The present utility model may be better understood by describing exemplary embodiments of the present application with reference to accompanying drawings. In the accompanying drawings:

FIG. 1 is a schematic diagram of an X-ray imaging system according to some embodiments of the present application;

FIG. 2A-2C are schematic diagrams of a tube assembly tilted at different angles according to some embodiments of the present application;

FIG. 3 is a schematic diagram of a tube tilting apparatus according to some embodiments of the present application;

FIG. 4 is a schematic diagram of a tube tilting apparatus according to some embodiments of the present application;

FIG. 5 is a schematic diagram of a tube and a fixing member of a tube tilting apparatus according to some embodiments of the present application;

FIG. 6 is an exploded view of a clamping member of a tube tilting apparatus according to some embodiments of the present application;

FIG. 7 is a schematic diagram of an assembled clamping member of a tube tilting apparatus according to some embodiments of the present application;

FIG. 8 is a cross-sectional view of some other embodiments of a clamping member of a tube tilting apparatus according to some embodiments of the present application;

FIG. 9 is a schematic diagram of an angle adjusting assembly of a tube tilting apparatus at a first angle according to some embodiments of the present application;

FIG. 10 is a schematic diagram of an angle adjusting assembly of a tube tilting apparatus at a second angle according to some embodiments of the present application; and

FIG. 11 is a schematic diagram of a buffer assembly according to some embodiments of the present application.

### DETAILED DESCRIPTION

Specific embodiments of the present utility model will be described in the following. It should be noted that during the specific description of these embodiments, it is impossible to describe all of the features of the actual embodiments in detail in this specification for the sake of brief description. It should be understood that in the actual implementation process of any embodiment, just as in the process of any one engineering project or design project, a variety of specific decisions are often made to achieve specific goals of the developer and to meet system-related or business-related constraints, which may also vary from one embodiment to another. In addition, it should also be understood that although efforts made in this development process may be complicated and lengthy, for those of ordinary skill in the art related to the content disclosed in the present utility model, some changes in design, manufacturing, or production based on the technical content disclosed in the present utility model are only conventional technical means, and it should not be interpreted as the content of the present utility model being insufficient.

Unless otherwise defined, the technical or scientific terms used in the claims and the specification are as they are usually understood by those of ordinary skill in the art to which the present utility model pertains. The terms such as “first” and “second” and similar terms used in the specification and claims of the patent application of the present utility model do not indicate any order, quantity, or importance, but are merely intended to distinguish between different constituents. The term such as “one” or “a/an” and similar terms do not indicate a limitation of quantity, but rather indicate the existence of at least one. The term such as “include” or “comprise” and similar terms indicate that an element or object preceding the term “include” or “comprise” encompasses elements or objects and equivalent elements thereof listed after the term “include” or “comprise”, and does not exclude other elements or objects. The term such as “connect” or “link” and similar terms are not limited to physical or mechanical connections, and are not limited to direct or indirect connections.

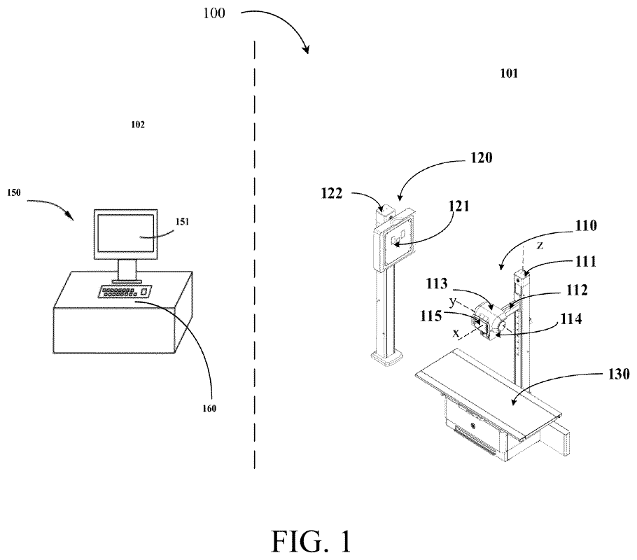

FIG. 1 shows an X-ray imaging system 100 according to some embodiments of the present utility model. As shown in FIG. 1, the X-ray imaging system 100 includes a tube stand apparatus 110, a detector stand apparatus 120 and an examination table apparatus 130 arranged in a scanning chamber 101, and a control apparatus 150 arranged in a control chamber 102. The tube stand apparatus 110 includes a stand 111, a cross arm 112, and a tube assembly (including a tube 113, a beam limiter 114, and a tube control apparatus 115). The cross arm 112 is configured to carry the tube assembly, and the cross arm 112 is mounted on the stand 111.

Although some embodiments of the present application are described based on a dual-stand X-ray imaging system, the embodiments of the present application are not limited thereto. For example, the medical imaging system may also be another type of X-ray imaging system, such as a movable X-ray imaging system; alternatively, the medical imaging system may also be another type of imaging system, such as a computerized tomography (CT) system, a positron emission tomography (PET) system and a magnetic resonance imaging (MRI) system.

For ease of description, in the present application, an x-axis, a y-axis, and a z-axis are defined such that the x-axis and the y-axis are located in a horizontal plane and perpendicular to each other, and the z-axis is perpendicular to the horizontal plane. Specifically, an extending direction of the cross arm 112 or a width direction of the examination table apparatus is defined as the x-axis, a direction in the horizontal plane perpendicular to the extending direction of the cross arm or a length direction of the examination table apparatus is defined as a y-axis direction, and an extending direction of the stand is defined as a z-axis direction, that is, the z-axis direction is a vertical direction.

The tube stand apparatus 110 further includes a guide rail mounted on a floor. The guide rail is arranged along the y-axis direction, and the stand 111 moves along the guide rail, i.e., along the y-axis direction. The cross arm 112 is further capable of moving along the vertical direction (i.e., the z-axis direction) relative to the stand 111. In addition, a tilting apparatus may be further provided between the tube assembly and the cross arm 112. The tilting apparatus may drive the tube assembly to tilt by a certain angle relative to the y-axis. Certainly, a rotating apparatus may be further provided between the tube assembly and the cross arm 112. The rotating apparatus may drive the tube assembly to rotate around the x-axis. The specific structures of the tilting apparatus and the rotating apparatus will be described below.

The tube is provided with an X-ray tube therein, and the X-ray tube may produce X-rays and project the X-rays to an intended region of interest (ROI) of a patient.

The beam limiter 114 is usually mounted below the X-ray tube, and the X-rays emitted by the X-ray tube irradiate on the body of a subject under examination by means of an opening of the beam limiter 114. An irradiation range of the X-rays, namely the region size of an exposure field of view (FOV), depends on the size of the opening of the beam limiter 114. It is well known that X-rays are harmful to the human body, so it is necessary to control the X-rays so that the X-rays only irradiate the site of the subject under examination that needs to be examined, namely, the region of interest (ROI).

The tube control apparatus 115 is mounted on the tube assembly. The tube control apparatus 115 includes user interfaces such as a display screen and a control button so as to perform preparations before image capture, such as patient selection, protocol selection, and positioning.

The detector stand apparatus 120 includes a first detector assembly 121, a second stand 122 and a connecting portion (not shown). The connecting portion includes a connecting arm that is vertically connected in a height direction of the second stand 122 and a rotating support that is mounted on the connecting arm. The first detector assembly 121 is mounted on the rotating support. The detector stand apparatus 120 further includes a detector driving apparatus that is arranged between the rotating support and the first detector assembly 121. The first detector assembly is driven by the detector driving apparatus to move in a direction parallel to the height direction of the second stand 122 in the plane supported by the rotating support, and the first detector assembly 121 may further be rotated relative to the connecting arm to form an angle with the stand. The first detector assembly 121 has a plate-like structure, the orientation of which is variable, facilitating an X-ray incident surface to become vertical or horizontal depending on an incident direction of the X-rays.

A second detector assembly (not shown) is arranged on the examination table apparatus 130. The selection or use of the first detector assembly 121 and the second detector assembly may be determined on the basis of an image capture site of a patient and/or an image capture protocol, or may be determined on the basis of the position of the subject under examination obtained by image capture by a camera, so as to perform image capture examination in a lying or standing position. FIG. 1 only shows an example diagram of a stand and an examination table, and it should be understood by those skilled in the art that stands and/or examination tables of any form or arrangement may be selected, or only the stand may be mounted, and the stand and/or examination table is not intended to limit the overall solution of the present application.

In some embodiments, the control apparatus 150 may include a source controller and a detector controller. The source controller is configured to command an X-ray source to emit X-rays for image exposure. The detector controller is configured to select a suitable detector from a plurality of detectors and to coordinate the control of various detector functions, for example, automatically select a corresponding detector according to the position or pose of the subject under examination. Alternatively, the detector controller may perform various signal processing and filtering functions, specifically, for initial adjustment of a dynamic range, interleaving of digital image data, etc. In some embodiments, the control apparatus 150 may provide power and timing signals for controlling the operations of the X-ray source and the detectors.

In some embodiments, the control apparatus 150 may further be configured to use a digitized signal to reconstruct one or more required images and/or determine useful diagnostic information corresponding to patients, where the control apparatus 150 may include one or more dedicated processors, graphics processing units, digital signal processors, microcomputers, microcontrollers, application-specific integrated circuits (ASICs), field-programmable gate arrays (FPGAs), or other appropriate processing apparatuses.

Certainly, the medical imaging system may also include other numbers or configurations or forms of control apparatuses. For example, the control apparatus may be local (e.g., co-located with one or more X-ray imaging systems 100, e.g., within the same facility and/or the same local network). In other implementations, the control apparatus may be remote, and thus only accessible through a remote connection (for example, via the Internet or other available remote access technologies). In a specific implementation, the control apparatus may also be configured in a cloud-like means, and may be accessed and/or used in a means that is substantially similar to the means by which other cloud-based systems are accessed and used.

The system 100 further includes a storage apparatus (not shown in the figure). A processor may store the digitized signal in a memory. For example, the memory may include a hard disk drive, a floppy disk drive, a CD-read/write drive, a digital versatile disc (DVD) drive, a flash drive, and/or a solid-state memory. The memory may also be integrated together with the processor to effectively use the floor area and/or meet expected imaging requirements.

The system 100 further includes an input apparatus 160. The input apparatus 160 may include a specific form of operator interface, such as a keyboard, a mouse, a voice-activated control apparatus, a touch screen (which may also be used as a display apparatus described later), a tracking ball, or any other suitable input devices. An operator may input an operation signal/control signal to the control apparatus by means of the input apparatus 160.

The system 100 further includes a display apparatus 151 (such as a touch screen or a display screen). The display apparatus 151 may be configured to display operation interfaces such as a list of subjects under examination, positioning or exposure settings of subjects under examination, and images of subjects under examination.

In the X-ray imaging system as shown in FIG. 1, the tube stand apparatus 110 includes the following movements: The stand 111 moves along the axis (y-axis) of the cross arm, the cross arm 112 drives the tube to move along the vertical direction (z-axis), the tube rotates around the axis (x-axis) of the cross arm, and the tube tilts upward or downward relative to the axis (y-axis) of the cross arm.

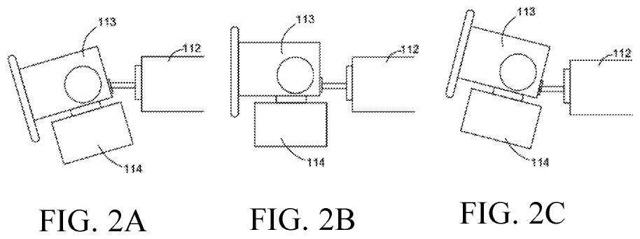

FIG. 2A-2C shows schematic diagrams of a tube assembly tilted at different angles according to some embodiments of the present application. As shown in FIG. 2B, the entire tube assembly (including a tube, a beam limiter 114 and a tube control apparatus 115) is vertically connected to the cross arm 112, that is, a reference line perpendicular to a screen surface of the tube control apparatus is parallel to the axis on which the cross arm is located, or the central ray of the X-ray beam emitted by the tube is in the vertical direction, and the angle of the tube assembly is 0 degrees at this time. As shown in FIG. 2A, the tube assembly can be tilted downward by a certain angle relative to the cross arm, for example, −15 degrees, −20 degrees, −30 degrees or −45 degrees. As shown in FIG. 2C, the tube assembly can be tilted upward by a certain angle relative to the cross arm, for example, 15 degrees, 20 degrees, 30 degrees or 45 degrees.

In order to realize the tilting of the tube assembly, it is usually necessary to provide a tilting apparatus to control the tilting movement of the tube, and generally, the tilting movement of the tube is manually controlled, for example, the tilting angle of the tube is adjusted by a nut or a spanner. This method requires a relatively large operating space, requires a relatively large operating force, and is inconvenient to control. Some methods use other mechanical structures for control, but the mechanical structures are complex, a relatively large space is occupied, and a relatively large operating force is required.

In order to solve the above problems or at least similar problems, the embodiments of the present application provide a tube tilting apparatus, which uses handles connected to connecting rods to control a toothed member (protrusion) to enter one of a plurality of stopping grooves on the tube, so as to control the tilting angle of the tube. By providing two handles and connecting rods, regardless of the angle to which the tube assembly rotates, one handle is in the field of view and operable space of operators, the toothed member can be controlled by any handle, and the required operating force is relatively small.

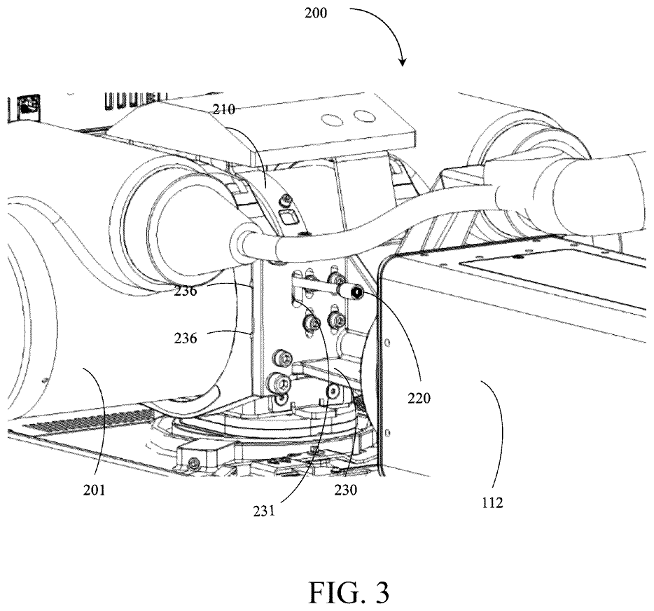

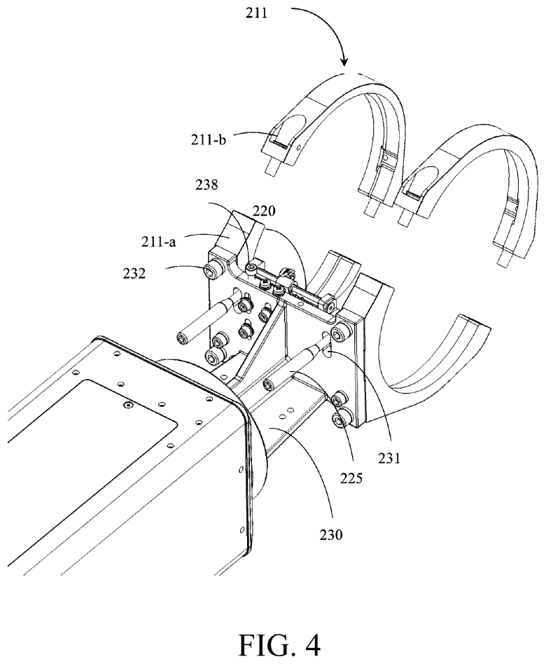

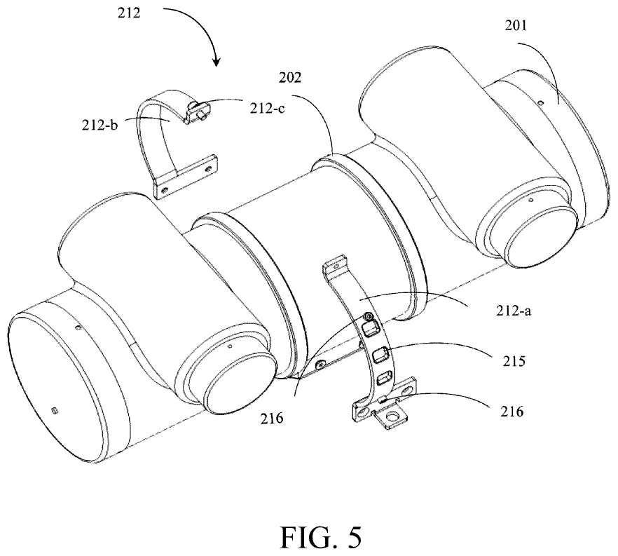

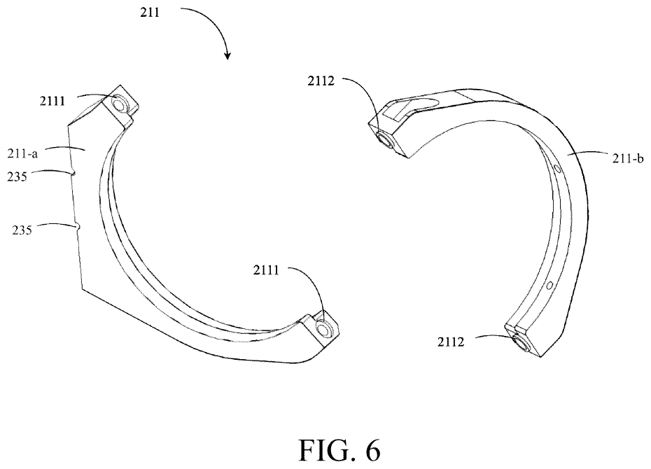

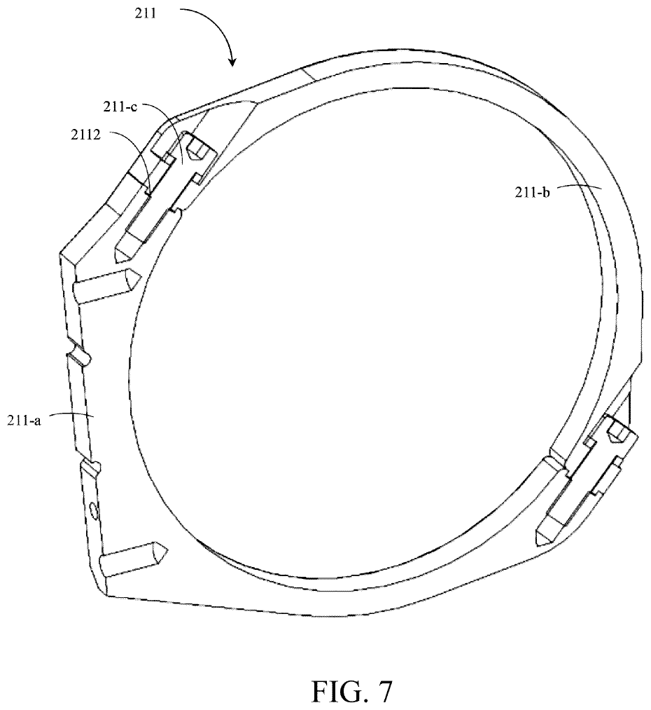

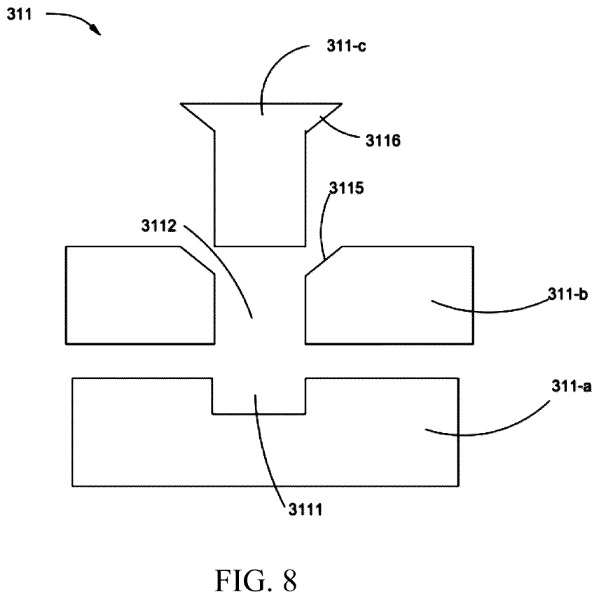

FIG. 3 shows a schematic diagram of a tube tilting apparatus according to some embodiments of the present application; FIG. 4 shows a schematic diagram of a tube tilting apparatus according to some embodiments of the present application; FIG. 5 shows a schematic diagram of a tube and a fixing member of a tube tilting apparatus according to some embodiments of the present application; FIG. 6 shows an exploded view of a clamping member of a tube tilting apparatus according to some embodiments of the present application; FIG. 7 shows a schematic diagram of an assembled clamping member of a tube tilting apparatus according to some embodiments of the present application; and FIG. 8 shows a cross-sectional view of some other embodiments of a clamping member of a tube tilting apparatus according to some embodiments of the present application. As shown in FIG. 3 to FIG. 7, the tube stand apparatus 110 further includes a tube tilting apparatus 200. The tube tilting apparatus 200 includes a tube holding assembly 210 and an angle adjusting assembly 220. The tube holding assembly 210 includes a clamping member 211 and a fixing member 212. The clamping member 211 is capable of holding a tube 201. The fixing member 212 is fixedly mounted on the tube 201, and the fixing member 212 is provided with a stopping groove 215. The stopping groove 215 defines a tilting angle of the tube 201. The angle adjusting assembly 220 includes a protrusion matching the stopping groove 215, and the protrusion is capable of being controlled to enter or leave the stopping groove 215, so as to realize the tilting movement of the tube relative to the cross arm.

In some embodiments, the tube stand apparatus 110 further includes a tube rotating apparatus (not shown in the figures). The tube rotating apparatus includes a rotating bracket 230. One end of the rotating bracket 230 is connected to the cross arm 112, and the other end of the rotating bracket is fixedly connected to the tube tilting apparatus 200.

In some other embodiments, the tube stand apparatus does not include the tube rotating apparatus, and the tube tilting apparatus 200 may be fixedly connected to the cross arm through a connecting bracket or other types of connecting components, which is not limited to the above solution.

Specifically, the clamping member includes two hoops, and each hoop includes a first hoop unit 211-a, a second hoop unit 211-b and a first connecting portion 211-c. An end of the first hoop unit 211-a is provided with a first hole. An end of the second hoop unit 211-b is provided with a second through hole. The first connecting portion 211-c is capable of fixing the first hoop unit 211-a and the second hoop unit 211-b by means of the first hole and the second through hole. In some embodiments, the first hoop unit and the second hoop unit are both in a semi-circular ring shape.

In some embodiments, an outer ring of one of the first hole and the second through hole is provided with a first groove, and an outer ring of the other of the first hole and the second through hole is provided with a first protrusion matching the first groove. The first groove and the first protrusion can be engaged when the first hoop unit and the second hoop unit are fitted together. Specifically, the first groove 2111 may be provided on the outer ring of the first hole, and the first protrusion 2112 may be provided on the outer ring of the second through hole. When the first hoop unit and the second hoop unit are fitted together, the first protrusion 2112 can enter the first groove 2111 and is engaged, and the first connecting portion 211-c can pass through the second through hole and is fixed in the first hole. Certainly, the first groove 2111 may also be provided on the outer ring of the second through hole, and the first protrusion 2112 may be provided on the outer ring of the first hole.

Certainly, the first groove 2111 and the first protrusion 2112 may not be provided on the outer rings of the first hole and the second through hole, and may also be provided at the end of the hoop unit but at a certain distance from the connecting hole, as long as the first protrusion 2112 and the first groove 2111 are positioned correspondingly.

By respectively providing the groove and the protrusion at the ends of the hoop units for fitting, the hoop units can be directly aligned when the hoop is mounted, the hoop units will not be misaligned and can be conveniently fixed by the connecting portion, and the hoop units will not be misaligned after being fitted together and fixed.

As shown in FIG. 8, in some other embodiments, each hoop of the clamping member 310 includes a third hoop unit 311-a, a fourth hoop unit 311-b and a connecting screw 311-c. An end of the third hoop unit 311-a is provided with a third hole 3111. An end of the fourth hoop unit 311-b is provided with a fourth through hole 3112. A side surface of the fourth through hole 3112 away from the fourth hoop unit has a slope (or a tilted surface) extending outward, that is, the fourth hoop unit 311-b includes a first surface and a second surface that are oppositely arranged. The fourth through hole 3112 penetrates through the first surface and the second surface, and the second surface is configured to be in contact with the third hoop unit, where a diameter of the fourth through hole 3112 on the first surface is greater than a diameter of the fourth through hole on the second surface. Furthermore, the connecting screw 311-c also has a body and an extension body, wherein the extension body also has a tilted surface 3116 matching the slope 3115 of the fourth through hole 3112. When the connecting screw 311-c is configured to connect the third hoop unit 311-a and the fourth hoop unit 311-b, the tilted surface 3116 of the extension body of the connecting screw 311-c can match and be in contact with the slope 3115 of the fourth through hole 3112, so as to limit a position at which the hoop units are fitted together.

Referring to FIG. 5, protruding portions 202 are provided on a surface of the tube 201, and a bent portion is also provided on an inner surface of the clamping member 211. During assembly, the bent portion of the clamping member 211 can be in contact with a protruding portion 202 of the tube 201, thereby realizing the holding of the tube 201 by the clamping member 211, wherein the term “holding” means that the clamping member can relatively fix the position of the tube, so that the tube cannot be displaced, but the tube can rotate relative to the clamping member.

Still referring to FIG. 5, the fixing member 212 includes a first fixing unit 212-a and a second fixing unit 212-b that are fitted together, and the first fixing unit 212-a and the second fixing unit 212-b are fixed by a second connecting portion 212-c. In some embodiments, the stopping groove is provided on the fixing unit closer to the cross arm, for example, on the first fixing unit 212-a. Specifically, the fixing member 212 can be fixed on the tube 201 by screws. When the tube 201 rotates, the fixing member 212 can rotate along with the tube 201.

In some embodiments, the fixing member 212 is provided with a plurality of stopping grooves 215, and each stopping groove corresponds to a different tilting angle. Preferably, the fixing member is provided with three stopping grooves 215 which respectively correspond to three positions of 0 degrees, 20 degrees and −20 degrees. Certainly, the fixing member 212 may also be provided with more or fewer stopping grooves, for example, two stopping grooves or four or more stopping grooves may be provided, and the number of stopping grooves may be set according to the image capture needs.

In some other embodiments, only one stopping groove (e.g., a slot) may be provided on the fixing member 212, but a plurality of stopping blocks are provided inside the stopping groove, so that a plurality of tilted positions are defined by the plurality of stopping blocks. Certainly, a plurality of grooves corresponding to tilting angles may also be provided in any other suitable manner. Certainly, the stopping groove 215 may also be provided as a rack (external teeth of the rack), that is, the fixing member is provided with a plurality of continuous tooth grooves, and the plurality of tooth grooves may be arranged at preset intervals to achieve the setting of more tilting angles. In cooperation, the protrusion (single-gear tooth) in the angle adjusting assembly is also provided to match the shape and size of the tooth groove, so that the protrusion can enter and leave the tooth groove and can be held in the tooth groove.

Two ends of the stopping groove 215 on the fixing member 212 are respectively provided with a limiting block 216 to limit a limit position of tilting of the tube. Specifically, the limiting block 216 can block the protrusion in the angle adjusting assembly 220, so that the protrusion cannot continue to move relative to the tube, and thus the maximum angle or the maximum position of tilting of the tube can be limited. Certainly, the position of the limiting block 216 may be customized according to the needs of users.

In some embodiments, when the tube rotates to a certain angle range around the x-axis of the cross arm, due to the gravity of the tube, when the protrusion does not enter the stopping groove (stays on the surface of the fixing member), the tube may also stop and remain in the tilted position thereof, so that the tube can be tilted to any angle and stop, and the requirements of a special image capture angle or image capture protocol can also be met.

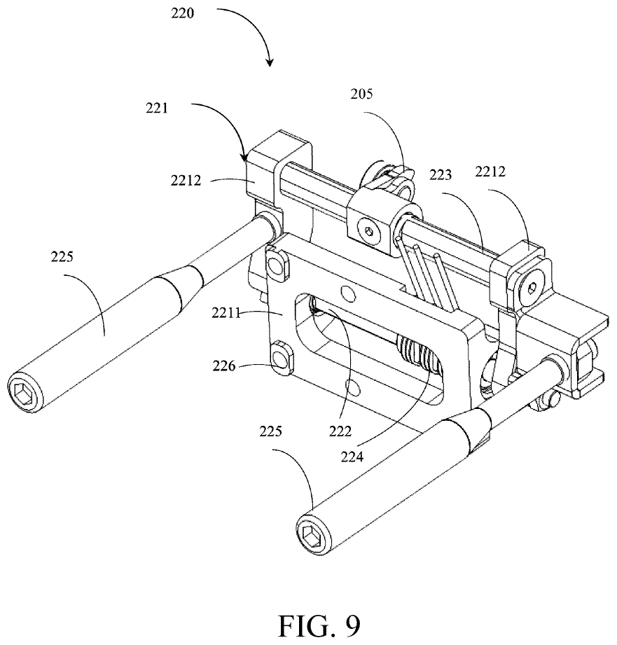

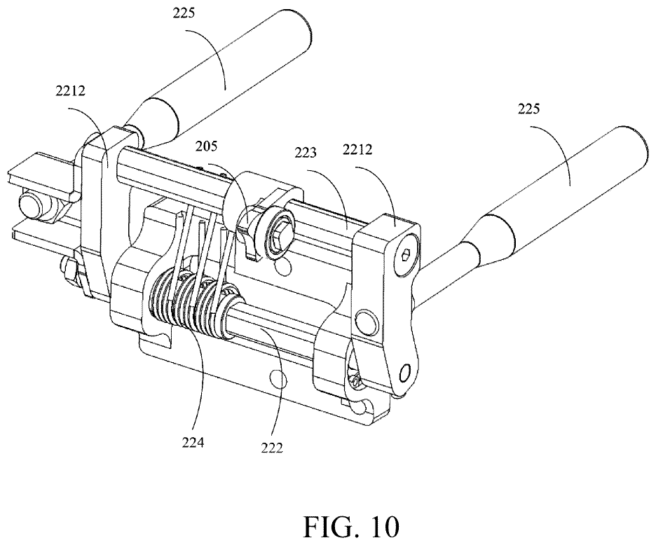

FIG. 9 shows a schematic diagram of an angle adjusting assembly of a tube tilting apparatus shown in FIG. 3 at a first angle; and FIG. 10 shows a schematic diagram of the angle adjusting assembly of the tube tilting apparatus shown in FIG. 3 at a second angle. As shown in FIG. 9 to FIG. 10, the angle adjusting assembly 220 includes a bracket 221, a first shaft 222 and a second shaft 223 that are arranged in parallel, an elastic member 224 and at least one grip portion 225. The bracket 221 includes a main portion 2211 and two side portions 2212. The first shaft 222 and the second shaft 223 are mounted between the two side portions 2212, and the protrusion 205 is provided on the second shaft 223. The elastic member 224 is wound around the first shaft 222, one end of the elastic member is supported on the main portion 2211, and the other end of the elastic member is fixed to the second shaft 223. The at least one grip portion 225 is mounted on the side portion 2212.

Specifically, the protrusion 205 is fixed to the second shaft 223 through a bearing, and one end of the protrusion 205 close to the fixing member is provided in a concave shape in the middle. By setting a concave shape in the middle and a convex shape at the periphery, it is convenient for the protrusion to enter and leave the stopping groove to adjust the tilting angle.

Specifically, the bracket 221 is connected to the rotating bracket 230 on one hand, and can carry the components of the entire angle adjusting assembly on the other hand. Specifically, the main portion 2211 of the bracket 221 is connected to the rotating bracket 230. Preferably, a group of second protrusions 226 are provided on a side of the main portion 2211 connected to the rotating bracket. Specifically, the main portion 2211 is provided with two second protrusions 226 arranged up and down on the same side of the main portion. Correspondingly, the rotating bracket is provided with two grooves correspondingly. By providing the second protrusions 226, the alignment between the rotating bracket 230 and the bracket 221 can be facilitated to facilitate the mounting. In some embodiments, the second protrusions 226 may also be arranged diagonally or in parallel at the position of a mounting hole shown in the main portion 2211. Those skilled in the art should understand that the second protrusions 226 are not limited to be present in pairs, and a plurality of second protrusions may also be provided to facilitate mounting and limiting.

In some embodiments, the first shaft 222 and the second shaft 223 are respectively fixed between the two side portions 2212, the main portion 2211 is substantially located on a side of the first shaft 222, and the main portion 2221 is provided with two through holes for the first shaft 222 to pass through.

In some embodiments, the cross section of the second shaft 223 is not circular, but is irregular. Preferably, the cross section of the second shaft is a rectangular ellipse, that is, a closed figure with arcs at upper and lower ends and a straight line in the middle. By providing the second shaft with an irregular cross section, deflection can be prevented to ensure that the protrusion can always be aligned with the position of the stopping groove. Certainly, the cross section of the second shaft may also be other irregular cross sections.

In some embodiments, the elastic member 224 is wound around the first shaft 222, one end of the elastic member is supported on the main portion 2211, and the other end of the elastic member presses the second shaft 223. Preferably, the other end of the elastic member presses a side of the second shaft away from the protrusion 205, so as to always apply an elastic force to the protrusion 205 toward the stopping groove or toward the direction of the tube. Specifically, the elastic member 224 is wound on one side of the first shaft, and certainly, the elastic member may also be wound on the other side or wound on both sides at the same time. In addition, even if there are three elastic members shown in the figure, those skilled in the art should also understand that any number of elastic members may be used, and the number of elastic members is not limited. In some embodiments, the elastic member 224 may also be a tensile or compressive elastic member which is fixed at a corresponding position, as long as the protrusion on the second shaft can be pressed toward the tube when there is no external force, and the protrusion can leave the stopping groove on the tube when there is an external force applied to the grip portion.

In some embodiments, the angle adjusting assembly in the present application includes two grip portions 225, the two grip portions 225 are respectively fixed to the two side portions 2212, any one grip portion can control the protrusion 205, and the grip portion 225 is fixedly mounted away from the protrusion 205. That is, the protrusion 205 in the angle adjusting assembly 220 is mounted or fixed adjacent to the tube 201, and the main portion 2211 of the bracket 221 and at least one grip portion 225 are all fixed to the other side (that is, the side close to the cross arm).

Preferably, an end of at least one grip portion 225 is provided with a hexagonal socket, which allows torque control and facilitates operations such as mounting and maintenance. In some embodiments, the end of at least one grip portion 225 may also have a polygonal cross section to achieve the same function.

In some embodiments, a connecting rod structure is formed between the two side portions 2212 and the second shaft 223, and the two side portions are respectively connected to a grip portion. By controlling any one grip portion, the connecting rod structure can be driven to rotate, thereby driving the protrusion 205 to enter or leave the stopping groove.

Referring to FIG. 3 and FIG. 4, the rotating bracket 230 includes at least one slot 231 thereon, the at least one slot 231 is capable of accommodating the at least one grip portion 225, and the at least one slot 231 is capable of defining a displacement distance of the at least one grip portion 225. Specifically, the rotating bracket is provided with two slots, and the two slots can respectively accommodate two grip portions. The slots are provided as rectangular ellipses, and the grip portions can move in a length direction of the slots.

In some embodiments, the rotating bracket 230 can also be configured to fix the clamping member. Specifically, the rotating bracket 230 and the clamping member 211 can be fixed by a third connecting portion 232. Specifically, by setting the distance among the rotating bracket 230, the clamping member 211 and the main portion 2211 of the bracket 221, it can be ensured that the protrusion is accommodated in the stopping groove, and the protrusion can leave the stopping groove under the action of the pressure of the grip portion.

In some preferred embodiments, a third group of grooves 235 (referring to the grooves 235 in FIG. 6) are provided on the side of the clamping member 211, and a third group of protrusions 236 matching the third group of grooves 235 are provided on the side of the rotating bracket 230. By providing the third group of grooves and protrusions between the clamping member and the rotating bracket, the alignment between the clamping member and the rotating bracket can be facilitated when the clamping member is mounted, so as to facilitate mounting and prevent deviation.

In some embodiments, an adjusting nut 238 is further provided on the rotating bracket 230, and the adjusting nut 238 can adjust and maintain an initial position of the angle adjusting assembly. Specifically, by tightening or loosening the adjusting nut 238, the accuracy of the initial tube at the 0-degree position can be adjusted, that is, it is ensured that when the protrusion is located in the stopping groove corresponding to 0 degrees, the central ray of the ray beam emitted by the tube is located in a vertical direction.

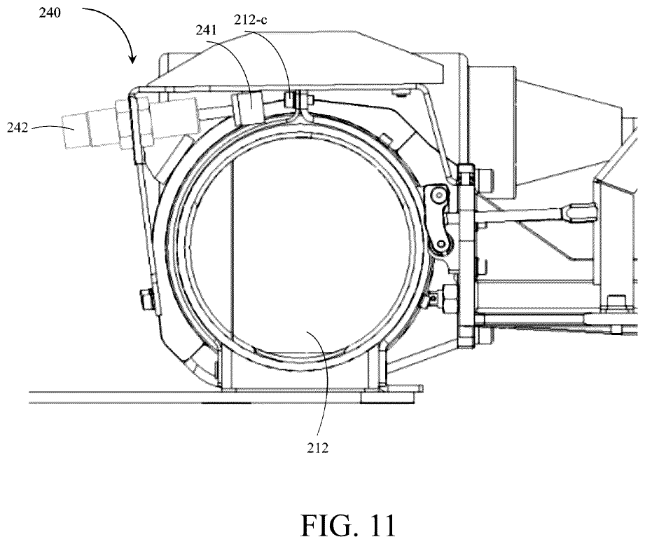

In addition, when the tube is controlled to perform a tilting movement, especially, when the tube is controlled to tilt downward, in the process of transferring the protrusion from one stopping groove to another stopping groove, due to the gravity of the tube, the tube will fall quickly in a small amplitude or small range, which causes poor user experience. In order to solve this problem, the present application also adds a buffer assembly to the tube tilting assembly. FIG. 11 shows a schematic diagram of a buffer assembly according to some embodiments of the present application. As shown in FIG. 11, the tube tilting apparatus includes a buffer assembly 240, and the buffer assembly is positioned adjacent to the second connecting portion 212-c of the fixing member.

The buffer assembly 240 includes a buffer member 241 and a hydraulic apparatus 242, one end of the buffer member has a preset distance from the second connecting portion 212-c, and the other end of the buffer member 241 is connected to the hydraulic apparatus 242. Specifically, the buffer member is hard plastic. When the tube tilts downward, the end is in contact with the buffer member, so that the tube can stop after moving quickly and then continue to tilt slowly to fall into the predetermined stopping groove.

According to the tube tilting apparatus in some embodiments of the present application, the tube is provided with a plurality of stopping grooves with tilting angles, the protrusion is controlled by the connecting rod structure, and the protrusion is controlled to enter different stopping grooves to control the tube to tilt to a preset angle, so that the structure is simple and control is simple. In addition, by providing two grip portions, control of the protrusion can be realized by controlling any one grip portion, so that control can be conveniently realized regardless of the rotation of the tube to any angle. Furthermore, by providing a protrusion and a groove between the angle adjusting assembly and the rotating bracket, providing a protrusion and a groove between the rotating bracket and the clamping member, or providing a protrusion and a groove between two groups of hoop units, deviation can be prevented, and alignment of position is facilitated, so that mounting is facilitated.

Some exemplary embodiments have been described above. However, it should be understood that various modifications may be made. For example, if the described technologies are executed in different orders and/or if assemblies in the described systems, architectures, devices or circuits are combined in different ways and/or replaced or supplemented by additional assemblies or equivalents thereof, suitable results can be achieved. Accordingly, other embodiments also fall within the scope of protection of the claims.

1. A tube stand apparatus, comprising:
a stand;
a cross arm mounted on the stand;
a tube; and
a tube tilting apparatus mounted between the tube and the cross arm, characterized in that the tube tilting apparatus comprises:
a tube holding assembly, comprising a clamping member and a fixing member, the clamping member being capable of holding the tube, the fixing member being mounted on the tube, and the fixing member being provided with a stopping groove, the stopping groove defining a tilting angle of the tube, and
an angle adjusting assembly, comprising a protrusion matching the stopping groove, the protrusion being capable of being controlled to enter or leave the stopping groove, so as to realize the tilting movement of the tube relative to the cross arm.

2. The tube stand apparatus according to claim 1, wherein the clamping member comprises two hoops, each hoop comprises a first hoop unit, a second hoop unit and a first connecting portion, an end of the first hoop unit is provided with a first hole, an end of the second hoop unit is provided with a second through hole, and the first connecting portion is capable of fixing the first hoop unit and the second hoop unit by means of the first hole and the second through hole.

3. The tube stand apparatus according to claim 2, wherein an outer ring of one of the first hole and the second through hole is provided with a first groove, an outer ring of the other of the first hole and the second through hole is provided with a first protrusion matching the first groove, and the first groove and the first protrusion can be engaged when the first hoop unit and the second hoop unit are fitted together.

4. The tube stand apparatus according to claim 1, wherein the fixing member comprises a first fixing unit and a second fixing unit that are fitted together, the first fixing unit and the second fixing unit are fixed by a second connecting portion, and the stopping groove is provided on the first fixing unit or the second fixing unit.

5. The tube stand apparatus according to claim 4, wherein the tube tilting apparatus further comprises a buffer assembly, and the buffer assembly is positioned adjacent to the second connecting portion.

6. The tube stand apparatus according to claim 5, wherein the buffer assembly comprises a buffer member and a hydraulic apparatus, one end of the buffer member has a preset distance from the second connecting portion, and the other end of the buffer member is connected to the hydraulic apparatus.

7. The tube stand apparatus according to claim 1, wherein two ends of the stopping groove on the fixing member are each provided with a limiting block to limit a limit position of tilting of the tube.

8. The tube stand apparatus according to claim 1, wherein the angle adjusting assembly comprises:
a bracket, comprising a main portion and two side portions;
a first shaft and a second shaft arranged in parallel, wherein the first shaft and the second shaft are mounted between the two side portions, and the protrusion is mounted on the second shaft;
an elastic member wound around the first shaft, wherein one end of the elastic member is supported on the main portion, and the other end of the elastic member is fixed to the second shaft; and
at least one grip portion mounted on the side portion.

9. The tube stand apparatus according to claim 8, wherein the at least one holding portion is mounted away from the protrusion.

10. The tube stand apparatus according to claim 8, wherein an end of the at least one grip portion is provided with a hexagonal socket.

11. The tube stand apparatus according to claim 8, wherein the angle adjusting assembly comprises two grip portions, the two grip portions are respectively mounted on the two side portions, and any one grip portion is capable of controlling the displacement of the protrusion.

12. The tube stand apparatus according to claim 8, wherein the second shaft has an irregular cross section.

13. The tube stand apparatus according to claim 8, wherein the tube stand apparatus further comprises a tube rotating apparatus, the tube rotating apparatus comprises a rotating bracket, one end of the rotating bracket is connected to the cross arm, and the other end of the rotating bracket is fixedly connected to the main portion.

14. The tube stand apparatus according to claim 13, wherein a group of second protrusions are provided on a side of the main portion connected to the rotating bracket.

15. The tube stand apparatus according to claim 13, wherein the rotating bracket comprises at least one slot thereon, the at least one slot is capable of accommodating the at least one grip portion, and the at least one slot is capable of defining a displacement distance of the at least one grip portion.

16. The tube stand apparatus according to claim 13, wherein the rotating bracket is further fixed to the clamping member, a third group of grooves are provided on a side edge of the clamping member, and a third group of protrusions matching the third group of grooves are provided on a side edge of the rotating bracket.

17. The tube stand apparatus according to claim 13, wherein an adjusting nut is further provided on the rotating bracket, and the adjusting nut is capable of adjusting an initial position of the angle adjusting assembly.

18. The tube stand apparatus according to claim 1, wherein one end of the protrusion close to the fixing member is provided in a concave shape in the middle.

19. An X-ray imaging system, comprising:
a tube stand apparatus, comprising:
a stand;
a cross arm mounted on the stand;
a tube; and
a tube tilting apparatus mounted between the tube and the cross arm, characterized in that the tube tilting apparatus comprises:
a tube holding assembly, comprising a clamping member and a fixing member, the clamping member being capable of holding the tube, the fixing member being mounted on the tube, and the fixing member being provided with a stopping groove, the stopping groove defining a tilting angle of the tube, and
an angle adjusting assembly, comprising a protrusion matching the stopping groove, the protrusion being capable of being controlled to enter or leave the stopping groove, so as to realize the tilting movement of the tube relative to the cross arm.
